(19) United States
(12) Patent Application Publication
(10) Pub. No.: US 2024/0177606 A1
(43) Pub. Date: May 30, 2024

(54) INFORMATION MANAGEMENT DEVICE

(71) Applicant: TOYOTA JIDOSHA KABUSHIKI KAISHA, Toyota-shi (JP)

(72) Inventors: Osami HASHIMOTO, Mishima-shi (JP); Hiroki TASHIMA, Fujisawa-shi (JP); Toshihiko INOUE, Nagoya-shi (JP); Kazuma TOYA, Anjo-shi (JP); Takashi TAZOE, Nagoya-shi (JP); Ryota BINGO, Nissin-shi (JP); Kosuke SAKAKIBARA, Toyota-shi (JP)

(73) Assignee: TOYOTA JIDOSHA KABUSHIKI KAISHA, Toyota-shi (JP)

(21) Appl. No.: 18/465,415

(22) Filed: Sep. 12, 2023

(30) Foreign Application Priority Data
Nov. 30, 2022 (JP) 2022-191785

(51) Int. Cl. G08G 1/14; G01C 21/36; G06V 20/13

(52) U.S. Cl. CPC G08G 1/143; G01C 21/3602; G01C 21/3685; G06V 20/13

(57) ABSTRACT

An information management device includes a travel route acquisition unit, a satellite image acquisition unit, and a detection unit. The travel route acquisition unit acquires a travel route of the vehicle. The satellite image acquisition unit acquires a satellite image in which the periphery of the travel route acquired by the travel route acquisition unit is captured. The detection unit detects one or more available spaces in the parking lot located around the travel route from the satellite image acquired by the satellite image acquisition unit.

### CROSS-REFERENCE TO RELATED APPLICATION

This application claims priority to Japanese Patent Application No. 2022-191785 filed on Nov. 30, 2022, incorporated herein by reference in its entirety.

### BACKGROUND

### 1. Technical Field

The present disclosure relates to information management devices.

### 2. Description of Related Art

WO2019/008762 discloses a guidance system that enables a user to smoothly move to an available space in a parking lot based on his or her selection. In the guidance system disclosed in WO2019/008762, a host computer generates an image in which one of available spaces in the parking lot is visible, based on an overhead image of the parking lot captured by a camera. The generated image is output to a car navigation system mounted on a vehicle by a communication function and displayed on a display device of the car navigation system.

### SUMMARY

The technique described in WO2019/008762 can guide a user to an available space in a parking lot, but cannot detect the availability of a plurality of parking lots.

In view of the above circumstances, it is an object of the present disclosure to provide an information management device that can detect the availability of a plurality of parking lots.

An information management device of a first aspect of the present disclosure includes: a travel route acquisition unit configured to acquire a travel route of a vehicle; a satellite image acquisition unit configured to acquire a satellite image of an area around the travel route acquired by the travel route acquisition unit; and a detection unit configured to detect one or more available spaces in a parking lot located in the area around the travel route from the satellite image acquired by the satellite image acquisition unit.

In the information management device of the first aspect, one or more available spaces in the parking lot located in the area around the travel route are detected from the satellite image of the area around the travel route. It is therefore possible to detect the availability of the parking lot located in the area around the travel route of the vehicle.

An information management device of a second aspect of the present disclosure may further include, in the configuration of the first aspect, a guide unit configured to guide the vehicle to the available space detected by the detection unit or to the parking lot with the available space.

In the information management device of the second aspect, the vehicle is guided to the detected available space or the parking lot with the available space. Therefore, a driver of the vehicle can easily move the vehicle to the available space.

According to an information management device of a third aspect of the present disclosure, in the configuration of the first or second aspect, the satellite image acquisition unit may be configured to periodically acquire the satellite image when the detection unit detects that the parking lot located in the area around the travel route is full, and the information management device may further include an estimation unit configured to estimate, by machine learning, a time when a parking space with a parked vehicle becomes available by calculating time during which the parked vehicle in the parking space has been stopped based on the satellite images periodically acquired by the satellite image acquisition unit.

The time when a parking space becomes available can be estimated using machine learning. That is, the time when a parking space becomes available may be estimated using a learned model that outputs the time when a parking space becomes available when a travel route including a parking lot and the time during which a vehicle has been stopped are input to the learned model. In this case, the learned model may perform model learning using, as training data, a plurality of training data sets composed of sets of the following two types of data: data including a travel route including the parking lot and the time during which a vehicle has been stopped, and data on the actual time when the parking space became available. As an example, the learned model is machine-learned by a known method such as deep learning.

In the information management device of the third aspect, the time when a parking space with a parked vehicle becomes available is estimated by calculating the time during which the parked vehicle in the parking space has been stopped based on the periodically acquired satellite images. Therefore, it is possible to estimate the wait time until a parking space becomes available when the parking lot is full.

An information management device of a fourth aspect of the present disclosure may further include, in the configuration of the second aspect, an interval detection unit configured to detect an interval between a vehicle stopped next to the available space and the available space, and the guide unit may be configured to guide the vehicle to the available space with a larger interval based on a detection result from the interval detection unit.

In the information management device of the fourth aspect, the interval between a vehicle stopped next to the available space and the available space is detected, and the vehicle is guided to the available space with a larger interval. Since the vehicle is guided to a wider available space, the driver can more easily park the vehicle.

According to an information management device of a fifth aspect of the present disclosure, in the configuration of any one of the first, second, and fourth aspects, the satellite image acquisition unit may be configured to acquire weather information associated with the acquired satellite image, and the information management device may further include a prediction unit configured to predict, by machine learning, a degree of shade in the one or more available spaces based on the weather information acquired by the satellite image acquisition unit.

The degree of shade can be predicted using machine learning. That is, the degree of shade in the available space may be predicted using a learned model that outputs the degree of shade in a parking space in a parking lot during a parking period when location information of the parking space and the parking period in the parking space are input to the learned model. In this case, the learned model may perform model learning using, as training data, a plurality of training data sets composed of sets of the following two types of data: data including the location information of the parking space in the parking lot and hourly weather information in the parking space in the parking lot, and data on the hourly ratios of the shaded area in the parking space. As an example, the learned model is machine-learned by a known method such as deep learning.

In the information management device of the fifth aspect, the degree of shade in the one or more available spaces is predicted based on the weather information. It is therefore possible to know which available space has more shade when there is a plurality of available spaces. An increase in temperature inside the vehicle and sun damage to the vehicle body surface can be reduced by parking the vehicle in an available space with a higher degree of shade. On the other hand, in the case of a vehicle etc. equipped with a photovoltaic power generation device on its top surface, the amount of power generation can be increased by parking the vehicle in an available space with a lower degree of shade.

As described above, the information management device according to the present disclosure is very advantageous in that it can detect the availability of a plurality of parking lots.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an example of a schematic configuration of an information management system according to a first embodiment of the present disclosure;

FIG. 2 is a block diagram showing a hardware configuration of a vehicle according to the first embodiment of the present disclosure;

FIG. 3 is a block diagram showing a hardware configuration of the center server according to the first embodiment of the present disclosure;

FIG. 4 is a block-diagram illustrating an exemplary functional configuration of a CPU in the center server according to the first embodiment of the present disclosure;

FIG. 5 is a flowchart illustrating an example of a flow of notification processing according to the first embodiment of the present disclosure;

FIG. 6 is a block-diagram illustrating an exemplary functional configuration of a CPU in a center server according to a second embodiment of the present disclosure;

FIG. 7 is a flowchart illustrating an example of a flow of notification processing according to the second embodiment of the present disclosure;

FIG. 8 is a block-diagram illustrating an exemplary functional configuration of a CPU in a center server according to a third embodiment of the present disclosure; and

FIG. 9 is a flowchart illustrating an example of a flow of notification processing according to the third embodiment of the present disclosure.

### DETAILED DESCRIPTION OF EMBODIMENTS

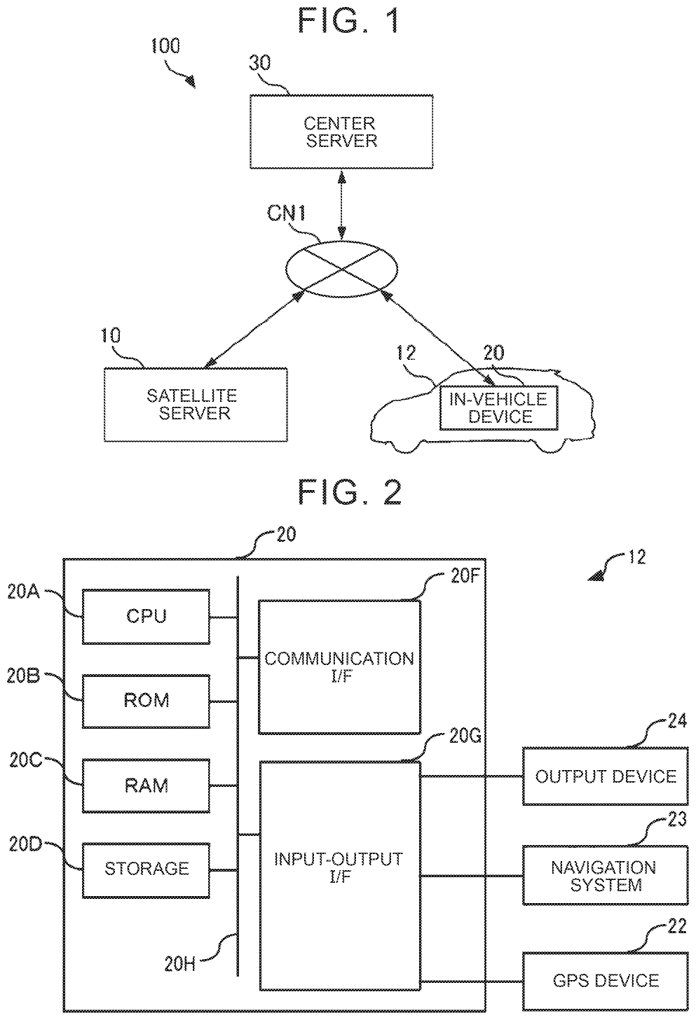

Hereinafter, an information management system 100 according to a first embodiment of the present disclosure will be described with reference to the accompanying drawings. As illustrated in FIG. 1, the information management system 100 according to the first embodiment includes a satellite server 10, a vehicle 12, and a center server 30. The center server 30 is an example of an information management device. The number of vehicles 12 included in the information management system 100 is not limited to the number illustrated in FIG. 1. The satellite server 10, the vehicles 12, and the center server 30 are connected to each other via a network CN1.

The satellite server 10 stores various satellite data, and as the satellite data, a satellite image that is an image on the ground captured by an artificial satellite, an aircraft, or the like, and a weather image such as an infrared image, a water vapor image, and a visible image captured by a weather satellite are stored. The weather image can confirm the state of clouds in various parts of Japan with a high-resolution image. Specifically, the shape and brightness of clouds can be observed in a visible image, and the temperature of clouds, sea and land can be observed in an infrared image. In addition, an invisible distribution of water vapor in the atmosphere can be observed in the water vapor image. By combining these observation data, the distribution of the weather is estimated, and the weather forecast is performed.

The satellite server 10 stores a satellite image, a date on which the satellite image is captured, and a point at which the satellite image is captured in association with each other. In addition, the satellite server 10 stores a weather image, a date when the weather image is captured, and a point at which the weather image is captured in association with each other. In addition, the satellite servers 10 also store map information and the like, and 30 transmit required map information via the network CN1 in response to a request from the vehicles 12.

The vehicle 12 includes an onboard device 20. The in-vehicle device 20 of the present embodiment is, for example, an Electronic Control Unit (ECU) that performs various controls. The vehicle 12 according to the present embodiment may be any of an engine-driven vehicle, a hybrid electric vehicle, and a battery electric vehicle.

Next, a hardware configuration of the vehicle 12 will be described. As illustrated in FIG. 2, the vehicle 12 includes an in-vehicle device 20, a Global Positioning System (GPS device 22, a navigation-system 23, and an output device 24.

GPS device 22 is a device that receives a GPS signal from GPS satellites to acquire location information as a current location of the vehicles 12. ECU 24 is a device that controls various types of vehicles 12 using electronic circuitry. The output device 24 includes a display device (not shown), a speaker (not shown), and the like. The display device displays various kinds of information on a display unit (not shown) provided in a vehicle cabin. Specifically, the display device causes the display unit to display, for example, information on a travel route set by the navigation system 23, information on a parking space, and the like. The speaker is provided in the vehicle cabin, and is configured to be capable of outputting sound to occupants.

The navigation system 23 sets a travel route from the current location of the vehicle 12 to the destination, and performs various guidance so that the vehicle 12 can travel along the travel route. At this time, the navigation system 23 acquires map information from the satellite server 10 as appropriate. In addition, when some or all of the map information is stored in a storage 20D, which will be described later, of the in-vehicle device 20, the travel route may be set without acquiring the map information from the satellite servers 10.

The in-vehicle device 20 includes a Central Processing Unit (CPU) 20A, Read Only Memory (ROM) 20B, Random Access Memory (RAM) 20C, a storage 20D, a communication I/F 20F, and an input/output I/F 20G. CPU 20A, ROM 20B, RAM 20C, the storage 20D, the communication I/F 20F, and the input/output I/F 20G are communicably connected to each other via an internal-bus 20H.

CPU 20A is a central processing unit that executes various programs and controls each unit. That is, CPU 20A reads the program from ROM 20B or the storage 20D, and executes the program using RAM 20C as a working area. CPU 20A performs control of the above-described configurations and various arithmetic processes in accordance with programs recorded in a ROM 20B or a storage 20D.

ROM 20B stores various programs and various data. RAM 20C temporarily stores a program/data as a working area. The storage 20D is constituted by Hard Disk Drive (HDD) or Solid State Drive (SSD) and stores various programs including an operating system and various data.

The communication I/F 20F is an interface for communicating with a network CN1, other devices, and the like, and standards such as Controller Area Network (CAN), Ethernet (Long Term Evolution (LTE)), Fiber Distributed Data Interface (FDDI), and Wi-Fi (registered trademark) are used.

The input/output I/F 20G are interfaces for communicating with devices mounted on the vehicles 12. A GPS device 22, a navigation system 23, and an output device 24 are connected to the in-vehicle device 20 of the present embodiment via an input/output I/F 20G. GPS device 22, the navigation system 23, and the output device 24 may be directly connected to the bus 20H.

### Center Server

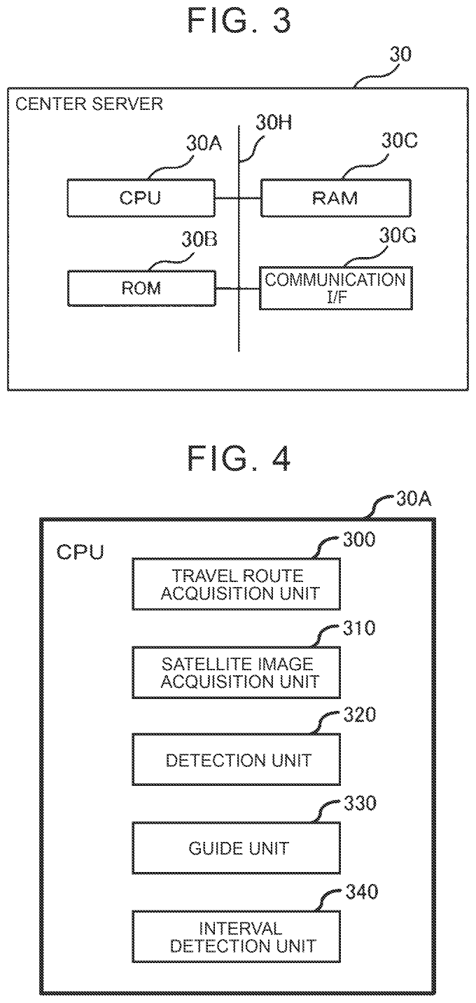

As illustrated in FIG. 3, the center server 30 includes a CPU 30A, ROM 30B, RAM 30C and a communication I/F 30G. CPU 30A, ROM 30B, RAM 30C and the communication I/F 30G are communicably connected to each other via an internal-bus 30H.

CPU 30A is a central processing unit that executes various programs and controls each unit. That is, CPU 30A reads the program from ROM 30B and executes the program using RAM 30C as a working area.

ROM 30B stores various programs and various data. RAM 30C temporarily stores a program/data as a working area. In ROM 30B of the present embodiment, an information-management program is stored. The information management program is a program for realizing each function of the center server 30.

A communication I/F 30G is an interface for connecting to a network CN1.

FIG. 4 is a diagram illustrating an exemplary functional configuration of a CPU 30A. As illustrated in FIG. 4, CPU 30A includes a travel route acquisition unit 300, a satellite image acquisition unit 310, a detection unit 320, a guide unit 330, and an interval detection unit 340. The respective functional configurations are realized by CPU 30A reading and executing an information-management program stored in ROM 30B.

The travel route acquisition unit 300 acquires a travel route from the current location of the vehicle 12 to the destination. Specifically, the current location of the vehicle 12 is set based on the data from GPS device 22, and the travel route from the current location of the vehicle 12 to the destination is calculated. The destination may be input to the center server 30 by an operation of an occupant or the like.

The calculation of the travel route may be performed by the in-vehicle device 20, or may be performed by an external satellite server 10 or the like. For example, by transmitting the current location information and the destination information of the vehicle 12 to the satellite server 10, the travel route may be calculated by the satellite server 10 side with reference to the map information. The travel route acquisition unit 300 acquires information related to the travel route calculated by the vehicle-mounted device 20 or the satellite server 10.

The satellite image acquisition unit 310 acquires a satellite image captured by an artificial satellite (not shown). Specifically, the satellite image acquisition unit 310 accesses the satellite server 10 and acquires a satellite image corresponding to the travel route from among the satellite images accumulated in the satellite server 10. In the present embodiment, the satellite image acquired by the satellite image acquisition unit 310 is a satellite image obtained by photographing the periphery of the travel route acquired by the travel route acquisition unit 300.

The detection unit 320 detects one or more available spaces in the parking lot located around the travel route from the satellite image acquired by the satellite image acquisition unit 310. The available space(s) need not necessarily be detected from one parking lot, and is detected from a plurality of parking lots. For example, the detection unit 320 refers to the parking lot information included in the map information from the vehicle-mounted device 20 or the satellite server 10, and detects a parking lot located around the traveling route. The detection unit 320 may detect, for example, a region in which a plurality of vehicles are parked in a satellite image, and detect the region as a parking lot.

The detection unit 320 detects an available space in each of the detected parking lots. Specifically, in the satellite image, a space in which the vehicle is not parked in the parking lot is detected. For example, when the parking space is partitioned by a line, a vehicle stop, or the like, it is detected whether or not the vehicle is parked in the partitioned area.

The guide unit 330 guides the vehicle 12 to the available space detected by the detection unit 320. Specifically, as an example, the travel route up to the available space is displayed on the display unit of the output device 24 via the navigation system 23. When a plurality of available spaces is detected, all travel routes to the available spaces are displayed. At this time, the travel route to the available space closer to the destination of the vehicle 12 or to the available space closer to the current location may be highlighted and displayed. As an example, the travel route to be highlighted can be selected by the occupant operating the navigation system 23.

As an example, the guide unit 330 may guide the vehicle 12 on the shortest route to the available space in conjunction with the one-way traffic information in the parking lot. In this case, the one-way traffic information can be detected, for example, by detecting an arrow drawn on the road surface of the parking lot in the satellite image.

The interval detection unit 340 detects an interval between a vehicle stopped next to an available space and the available space. The interval detection by the interval detection unit 340 can be performed using a satellite image. Specifically, for example, when an available space is defined by white lines etc., the interval detection unit 340 detects an interval between a vehicle that is stopped next to the available space and a white line that is closer to the vehicle. For example, in the case of an available space that is not defined by white lines etc, and in the case where the vehicle is stopped on both sides of the available space, the interval between the vehicles that are stopped next to each other is detected.

The guide unit 330 guides the vehicle 12 to an available space with a larger detected interval, based on the detection result by the interval detection unit 340.

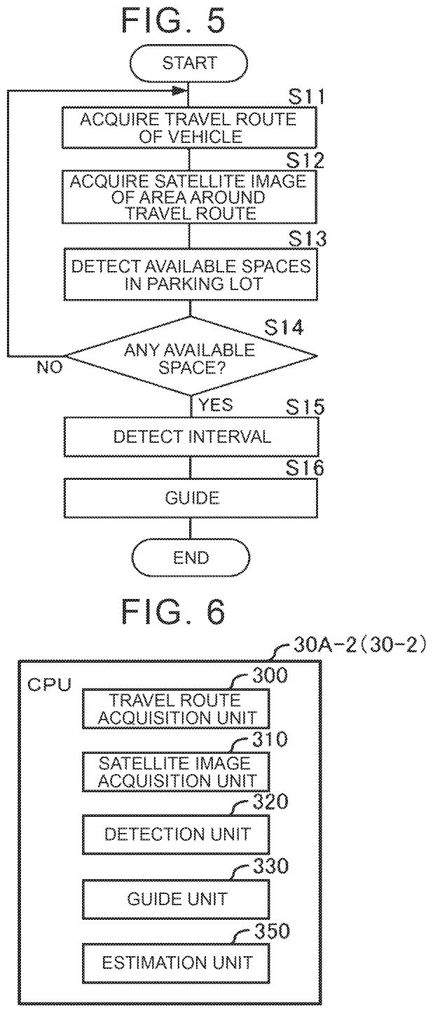

Next, the flow of the information management processing will be described with reference to FIG. 5. CPU 30A reads the information management program from ROM 30B, develops the information management program in RAM 30C, and executes the information management process. The satellite server 10 sequentially acquires and stores satellite data.

As illustrated in FIG. 5, first, in S11, the travel route acquisition unit 300 acquires the travel route of the vehicle 12 as described above. Next, in S12, the satellite image acquisition unit 310 acquires the satellite image in which the surroundings of the travel route are captured from the satellite servers 10.

In S13, as described above, the detection unit 320 detects an available space in the parking lot located around the travel route from the satellite-image. Next, CPU 30A determines whether there is an available space detected by the detection unit 320. When there is no available space (S14;NO), the CPU 30A proceeds to S11.

On the other hand, when there is an available space in S14 (S14; YES), the interval detection unit 340 detects the interval between the vehicle stopped next to the available space and the available space in S15 as described above. When only one available space is detected by the detection unit 320 in S13, S15 is omitted.

Next, in S16, the guide unit 330 guides the vehicles 12 to the available space detected by the detection unit 320 as described above. When an available space is detected in a plurality of parking lots located on the travel route acquired by the travel route acquisition unit 300, the guide unit 330 guides an available space closer to the destination of the vehicle 12 or an available space closer to the current location in accordance with the setting by the occupant. In the case where a plurality of available spaces is detected by the detection unit 320 in the parking lot, the guide unit 330 guides the vehicle 12 to an available space with a larger interval detected by the interval detection unit 340.

Next, the operation and effect of the center server 30 as the information management device according to the first embodiment will be described.

The center server 30 of the present embodiment detects one or more available spaces in the parking lot located around the traveling route from the satellite image obtained by capturing the surroundings of the traveling route of the vehicle 12. Therefore, it is possible to detect an empty state of the parking lot located around the travel route of the vehicle 12. Further, when the parking lot located around the travel route of the vehicle 12 is a large parking lot such as a shopping mall or a home center, it is possible to detect an available space in the large parking lot.

The center server 30 according to the present embodiment guides the vehicle 12 to the detected available space. Therefore, the driver of the vehicle 12 can easily move the vehicle 12 to the available space.

In addition, the center server 30 according to the present embodiment detects an interval between a vehicle that is stopped next to an available space and the available space, and guides an available space with a larger interval. Therefore, since a wider available space is guided, the driver can easily park the vehicle 12.

Next, a center server 30-2 as an information management device according to a second embodiment of the present disclosure will be described. In the present embodiment, the same reference numerals are used to denote the same components as those in the first embodiment, and detailed description thereof will be omitted.

As illustrated in FIG. 6, CPU 30A-2 of the center server 30-2 of the present embodiment further includes the estimation unit 350 without the interval detection unit 340 for CPU 30A configuration of the center server 30 of the first embodiment. In the present embodiment, the satellite image acquisition unit 310 periodically acquires satellite images at predetermined intervals.

When the detection unit 320 detects that the parking lot located around the traveling route is full, the estimation unit 350 estimates an empty time of the parking space by calculating the time during which the vehicle parked in the parking space has been stopped based on the satellite image periodically acquired by the satellite image acquisition unit 310.

In the present embodiment, as an example, the estimation of the time when the parking space becomes available is performed using machine learning. Specifically, the time when a parking space becomes available is estimated using a learned model that outputs the time when a parking space becomes available when a travel route including a parking lot, time during which a vehicle has been stopped, and the like are input to the learned model. In this case, in the learned model, model learning is performed using, as teacher data, a plurality of training data sets composed of a set of data including a travel route including a parking lot and time during which a vehicle has been stopped and data of an actual time when the parking space became available. As an example, the learned model is machine-learned by a known method such as deep learning.

The estimation method by the estimation unit 350 is not limited to the above, and for example, an average value of the parking time may be calculated in advance in each parking lot, and an empty time of the parking space of the vehicle may be estimated based on a difference between the average value and the current parking time of the currently parked vehicle.

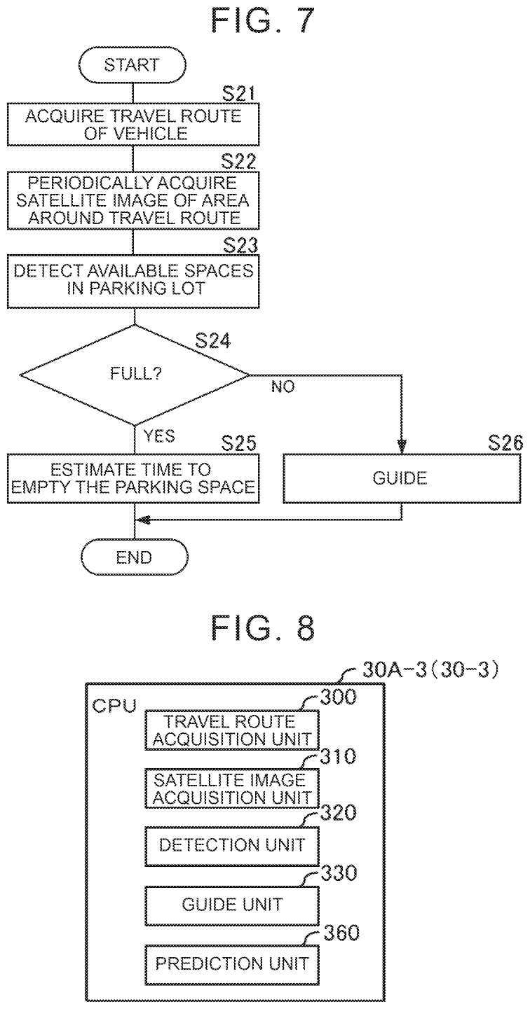

Next, the flow of the information management processing will be described with reference to FIG. 7. CPU 30A-2 reads the information management program from ROM 30B, develops the information management program in RAM 30C, and executes the information management process. The satellite server 10 sequentially acquires and stores satellite data.

As illustrated in FIG. 7, the travel route acquisition unit 300 first acquires the travel route of the vehicle 12 by S21. Next, in S22, the satellite image acquisition unit 310 periodically acquires the satellite image in which the surroundings of the travel route are captured from the satellite servers 10.

In S23, the detection unit 320 detects an available space in the parking lot located around the travel route from the satellite-image. Next, CPU 30A-2 determines whether the parking lot detected by the detection unit 320 is full. When the parking space is full (S24; YES), the estimation unit 350 estimates the time when the parking space becomes available in S25 as described above. Note that the estimated time when the parking space becomes available is notified to the occupant by being output by the output device 24.

On the other hand, when the vehicle is not full in S24 (S24;NO), the guide unit 330 guides the vehicle 12 to the available space detected by the detection unit 320 in S26.

Next, the operation and effect of the center server 30-2 as the information management device according to the second embodiment will be described.

The center server 30-2 of the present embodiment estimates an empty time of a parking space by calculating the time during which a vehicle parked in the parking space has been parked based on the periodically acquired satellite images. Therefore, it is possible to estimate how long the parking space is empty when the parking lot is full.

Next, a center server 30-3 as an information management device according to a third embodiment of the present disclosure will be described. In the present embodiment, the same reference numerals are used to denote the same components as those in the first embodiment, and detailed description thereof will be omitted.

As illustrated in FIG. 8, CPU 30A-3 of the center server 30-3 of the present embodiment further includes a prediction unit 360 and does not include the interval detection unit 340 in the configuration of the CPU 30A of the center server 30 of the first embodiment. In the present embodiment, the satellite image acquisition unit 310 also acquires weather information associated with the acquired satellite image.

The prediction unit 360 predicts the degree of shade in the available space detected by the detection unit 320 based on the weather information acquired by the satellite image acquisition unit 310.

In the present embodiment, as an example, the degree of shade is predicted by using machine learning. Specifically, by inputting the location information of the parking space of the parking lot, the time to park in the parking lot, and the like, the degree of shade in the available space is predicted using a learned model that outputs the degree of shade in the parking space in the parking time. In this case, in the learned model, model learning is performed using, as teacher data, a plurality of learning data sets each composed of a set of data including location information of a parking space of the parking lot and weather information of each time in a parking space of the parking lot, and data of a ratio of a sunshade area of each time in the parking space. As an example, the learned model is machine-learned by a known method such as deep learning.

The prediction method by the prediction unit 360 is not limited to the above, and for example, the average value of the ratio of the daily shade area for each time in each parking space may be calculated in advance for each of the fine weather, the rainy weather, and the cloudy weather as an example. In this case, based on the weather information acquired by the satellite image acquisition unit 310, the average value of the ratio of the shade area calculated in any one of the sunny weather, the rainy weather, and the cloudy weather may be predicted as the degree of shade.

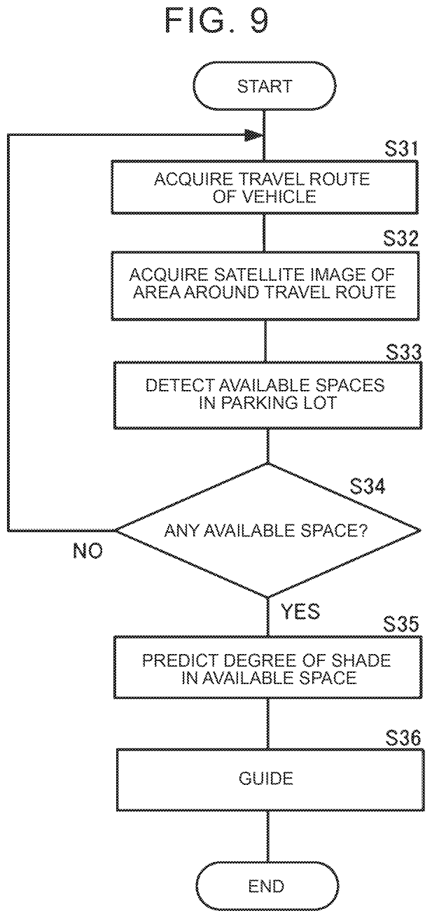

Next, the flow of the information management processing will be described with reference to FIG. 9. CPU 30A-3 reads the information management program from ROM 30B, develops the information management program in RAM 30C, and executes the information management process. The satellite server 10 sequentially acquires and stores satellite data. In addition, since the processing of S34 from S31 of FIG. 9 is the same as the processing of S14 from S11 of FIG. 5, only the different processing will be described.

As illustrated in FIG. 9, when there is an available space in S24 (S34; YES), the prediction unit 360 predicts the degree of shade in the available space as described above. Here, the degree of shade during the time when the passenger is scheduled to park is predicted.

Next, in S36, the guide unit 330 guides the vehicles 12 to the available space detected by the detection unit 320 by the guide unit 330.

Next, the operation and effect of the center server 30-3 as the information management device according to the third embodiment will be described.

The center server 30-3 of the present embodiment predicts the degree of shade in one or more available spaces based on the weather information. Therefore, when there is a plurality of available spaces, it is possible to know which available space has more shade. Accordingly, by parking the vehicle in an available space with a higher degree of shade, it is possible to reduce an increase in temperature inside the vehicle and sun damage to the vehicle body surface. On the contrary, in a vehicle etc. equipped with a photovoltaic power generation device on its top surface, the amount of power generation can be increased by parking the vehicle in an available space with a lower degree of shade.

### Remarks

In the first embodiment, the guide unit 330 guides the vehicle 12 to the detected available space, but the present disclosure is not limited to this. The guide unit 330 may guide the vehicle 12 to a parking lot with the detected available space. In this case, the driver can stop the vehicle at his desired available space in the actually arrived parking lot.

Although CPU 30A of the center server 30 according to the first embodiment includes the interval detection unit 340, the present disclosure is not limited to this, and the interval detection unit 340 may not be provided.

In CPU 30A-2 of the center server 30-2 according to the second embodiment, the detection unit 320 may detect a parking lot having a higher frequency of becoming full. In this case, it is possible to set a new parking lot in the vicinity of the parking lot having a higher frequency of being full.

The CPU 30A-2 of the center server 30-2 according to the second embodiment and the CPU 30A-2 of the center server 30-3 according to the third embodiment may further include the interval detection unit 340 according to the first embodiment.

Further, in the above-described embodiment, for example, when the detection unit detects a parking lot of a shop such as a home center or a supermarket, the detection unit may further detect a vehicle that has turned U at the entrance of the parking lot, and may estimate that the vehicle that has turned U is a vehicle that has abandoned parking because the shop is crowded. By making the opportunity loss visible in this way, it is possible to reduce the peak time of the congestion of the parking lot, for example, by shifting the time period of the sale performed in the time period in which the U-turn vehicle is large.

In the above-described embodiment, the center servers 30, 30-2, and 30-3 configured separately from the vehicle 12 are used as the information management device, but the present disclosure is not limited to this example. A built-in device in the vehicle 12 may be applied as the information management device. Instead of the vehicle 12, a user terminal owned by the user may be used. In this case, a device built in the user terminal may be applied as the information management device.

Further, in the above-described embodiment, the satellite data is stored in the satellite server 10 configured separately from the center server 30. However, it is not limited to this example. Satellite data may be stored in a storage device such as a ROM 30B or a storage included in the center server 30.

In addition, various processors other than CPU may execute the process executed by CPU reading the software (program) in the above-described embodiment. Examples of the processor include a Programmable Logic Device (PLD) in which a circuit configuration can be changed after manufacturing of Field-Programmable Gate Array (FPGA), and the like, and a dedicated electric circuit that is a processor having a circuit configuration designed exclusively for executing a particular process such as Application Specific Integrated Circuit (ASIC), and the like. Further, the above-described process may be executed by one of the various processors, or may be executed by a combination of two or more processors (for example, a plurality of FPGA, a combination of CPU and FPGA, and the like) of the same type or different types. The hardware structure of each of the various processors is, more specifically, an electric circuit in which circuit elements such as semiconductor elements are combined.

Further, in the above-described embodiment, an aspect in which the programs are stored (installed) in ROM in advance has been described, but the present disclosure is not limited thereto. The program may be provided in a form recorded in a recording medium such as Compact Disc Read Only Memory (CD-ROM), Digital Versatile Disc Read Only Memory (DVD-ROM), and Universal Serial Bus (USB). Further, the program may be downloaded from an external device via a network.

The flow of the processing described in the above-described embodiment is also an example, and unnecessary steps may be deleted, new steps may be added, or the processing order may be changed without departing from the gist.

In addition, the configuration of each of the satellite server 10, the vehicle 12, and the center server 30 described in the above-described embodiment is an example, and may be changed according to a situation within a range that does not depart from the gist.

What is claimed is:

1. An information management device, comprising:
a travel route acquisition unit configured to acquire a travel route of a vehicle;
a satellite image acquisition unit configured to acquire a satellite image of an area around the travel route acquired by the travel route acquisition unit; and
a detection unit configured to detect one or more available spaces in a parking lot located in the area around the travel route from the satellite image acquired by the satellite image acquisition unit.

2. The information management device according to claim 1, further comprising a guide unit configured to guide the vehicle to the available space detected by the detection unit or to the parking lot with the available space.

3. The information management device according to claim 1, wherein the satellite image acquisition unit is configured to periodically acquire the satellite image when the detection unit detects that the parking lot located in the area around the travel route is full, the information management device further comprising an estimation unit configured to estimate, by machine learning, a time when a parking space with a parked vehicle becomes available by calculating time during which the parked vehicle in the parking space has been stopped based on the satellite images periodically acquired by the satellite image acquisition unit.

4. The information management device according to claim 2, further comprising an interval detection unit configured to detect an interval between a vehicle stopped next to the available space and the available space, wherein the guide unit is configured to guide the vehicle to the available space with a larger interval based on a detection result from the interval detection unit.

5. The information management device according to claim 1, wherein the satellite image acquisition unit is configured to acquire weather information associated with the acquired satellite image, the information management device further comprising a prediction unit configured to predict, by machine learning, a degree of shade in the one or more available spaces based on the weather information acquired by the satellite image acquisition unit.
